(19) United States
(12) Patent Application Publication
(10) Pub. No.: US 2006/0186110 A1
(43) Pub. Date: Aug. 24, 2006

(54) Electric heater with resistive carbon heating elements

(76) Inventors: Mark Campello, Felton, CA (US); Derek R. Pietz, Fresno, CA (US)

Correspondence Address: ESCO CORPORATION, 2141 NW 25TH AVENUE, P.O. BOX 10123, PORTLAND, OR, 97210, US

(21) Appl. No.: 11/065,518

(22) Filed: Feb. 22, 2005

(51) Int. Cl. H05B 3/68

(52) U.S. Cl. 219/444.1

(57) ABSTRACT

A heater, such as a susceptor for use in electronics industry manufacturing processes, and a method for manufacture of such a heater. A resistance heating assembly includes a carbon fiber reinforced carbon conductor and the heating element is free to move slightly relative to an outer casing in response to differences between the coefficients of thermal expansion of the resistance heating element and the outer casing. A resistance heating element of carbon is potted to protect against oxidation. A slip layer of a powdered ceramic allows movement of the heating element relative to a housing.

### BACKGROUND OF THE INVENTION

The present invention relates to electrical resistance heaters and particularly to such a heater suitable for relatively high temperature use, for example, as a susceptor in electronics industry manufacturing processes.

Various needs exist for reliable, high temperature heaters that can be brought to a desired temperature with a minimum of delay. For example, manufacturing processes for such items as semiconductor wafers and glass plates for use in display screens require the ability to provide a uniform temperature over a large heating surface of a susceptor on which such a wafer or glass plate is supported during the process. For example, chemical vapor deposition of thin coatings on such materials requires heating the materials on which deposition is to be accomplished to an accurately controlled temperature. For best results the temperature should be uniform over the entire area where deposition is desired, which may be quite large, as in the case of glass panels for use in display devices.

Because the equipment in which some such processes is carried out is extremely expensive, it is important to be able to raise the temperature from ambient temperatures to a required processing temperature such as a temperature in the range from 325° C., to as high as 500° C., in a short time, in order to minimize the amount of time during which the equipment is not at operating temperature.

Some previously available heaters for use in such processes have utilized so-called “cable” type resistive heating elements in which resistive nickel-chromium wires are encased in housings which are fitted into the metal heat sink or body of a heater in order to conduct heat to a required location. The structure of such heating elements imposes limitations on the configuration of the heating elements which make it difficult for a heater to provide uniform temperature distribution over a large area of a heater's heating surface. Such heating elements must operate at or near their limiting temperatures in a high temperature heater or susceptor. The need for limiting the maximum temperature of such heating elements, and the differential in thermal expansion, between the exterior body portions, or case, of a heater and the heating elements themselves within the heater, create limitations on the rate of increasing or decreasing the temperature of the heaters.

Electrical resistance heaters using etched foil resistive conductors deposited on insulating carriers made of materials such as mica or polyimide materials are known, but are not capable of providing enough heat, or of being operated at the high temperatures required for certain processes utilized in manufacturing of semiconductor products and glass panels utilized in electronics industry products such as LCD display panels.

The use of carbon fiber reinforced carbon electrical conductors as resistance heating elements is known, but for high temperature applications, such conductors have previously had to be used in inert atmospheres or in a vacuum, since at high temperatures the carbon conductors are susceptible to failure as a result of oxidation.

Because some processes in which a heater is needed require a carefully controlled atmosphere around such a heater, a heater must not produce emissions or give off materials that would alter the desired atmosphere within a processing chamber in which the heater is used. Watanabe U.S. Pat. No. 6,557,747 discloses manufacture of a gas-tight container for a heater or other internal components, but does not address the subject of differences in the thermal expansion of such a sealed container and the enclosed heating elements or other components.

What is desired, then, is a heater which can be raised quickly to high temperatures without resulting failure of the resistance heating elements, which does not emit gases as a result of being hot, and which can be controlled to provide a desired temperature accurately and uniformly over the entire area of a heating plate portion of such a heater.

### SUMMARY OF THE INVENTION

The present invention provides an electric resistance heater and a method for manufacturing such a heater that answers the aforementioned shortcomings of previously available electric heaters. In accordance with one aspect of the invention a heater includes a case having an exterior heating surface, an electrical heating unit contained within and electrically insulated from the housing and having a resistance heating element, and in which the heating element is held within the housing so that relative movement in response to changing temperature of at least one of the housing and the heating element is able to be accommodated by relative movement between the heating element and the interior of the housing.

As another aspect of the invention the electric heating element utilized in such a heater is of a conductive carbon material and the structure of the heater isolates the carbon material from contact with the environment surrounding the outside of the heater.

As yet another aspect of the invention a method is provided for assembling a heater by providing a housing defining a cavity, providing a slip layer of material within the housing between an interior surface of the housing and an electric resistance heating element, installing electrically insulating material between the slip layer and the resistance heating element, and closing the housing.

The foregoing and other objectives, features, and advantages of the invention will be more readily understood upon consideration of the following detailed description of the invention, taken in conjunction with the accompanying drawings.

### BRIEF DESCRIPTION OF THE SEVERAL VIEWS OF THE DRAWINGS

FIG. 1 is an elevational view of a heater which includes one exemplary embodiment of the present invention, showing the heater in place and supporting a glass plate being coated in a vapor deposition process chamber shown schematically.

FIG. 2 is an isometric view of the heater shown in FIG. 1, showing the susceptor or planar heating surface thereof.

FIG. 3 is an isometric view showing the bottom of the heater shown in FIGS. 1 and 2, with the heater inverted.

FIG. 4 is an exploded view of the heater shown in FIGS. 1-3.

FIG. 5 is a sectional view of a part of the heater shown in FIGS. 1-4, taken along line 5-5 of FIG. 3.

FIG. 6 is a sectional view, taken along line 6-6 of FIG. 3, of a central portion of the heater shown in FIGS. 1-5, showing the arrangement of electrical terminals and insulators.

FIG. 7 is an isometric view of the upper member of the housing portion, or case, of the heater shown in FIGS. 1-6, inverted, at a first step in the assembly of the heater.

FIG. 8 is a view similar to FIG. 7, showing the upper member of the housing with a layer of insulating material, shown in partially cutaway view installed.

FIG. 9 is a plan view of a pair of electrical resistance heating elements for one quadrant of the heater shown in FIGS. 1-6.

FIG. 10 is an exploded isometric detail view of an electrical terminal for one of the heating elements of the heater.

FIG. 11 is an isometric view of the electrical terminal shown in FIG. 10 in an assembled condition.

FIG. 12 is an isometric view at a next subsequent stage of assembly of the heater shown in FIG. 11, with resistive heating elements in place, and showing the arrangement of the heating element electrical terminals and thermocouple leads in the central portion of the heater.

FIG. 13 is a view similar to FIG. 12, showing the next step of assembly of the heater, in which potting material is installed.

FIG. 14 is an isometric view showing the heater at a subsequent stage of the assembly procedure, after installation of additional layers of insulating material, and with a cover plate ready to be installed.

FIG. 15 is an isometric view of the heater with cover plates and a connector tube base portion in their required positions and showing the heater connected to a vacuum hose.

FIG. 16 is an isometric view of a heater which is another embodiment of the present invention.

### DETAILED DESCRIPTION OF PREFERRED EMBODIMENTS

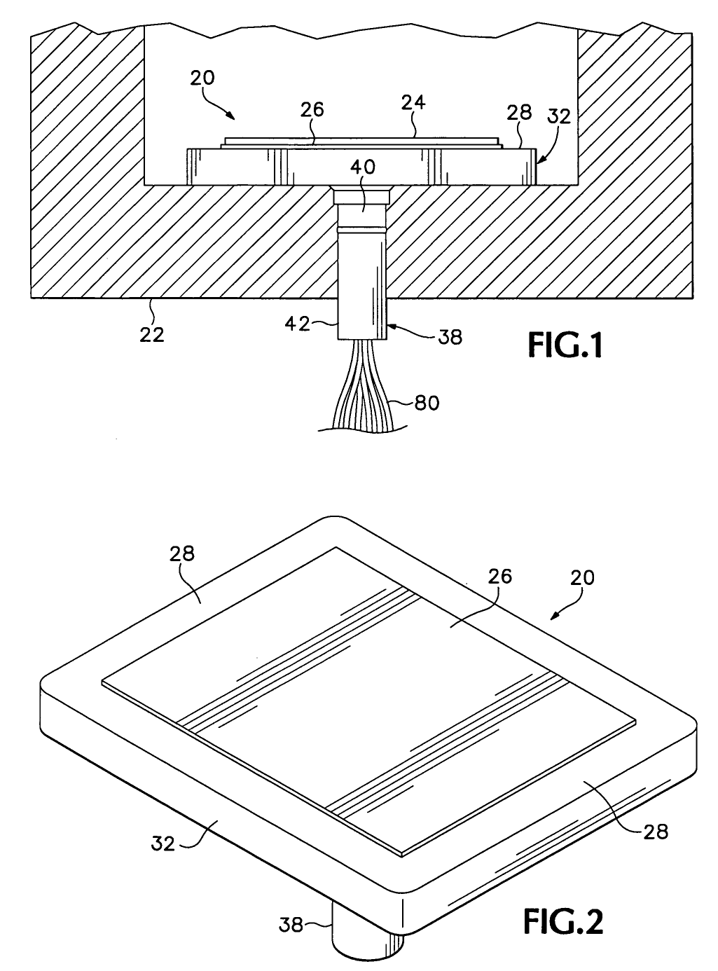

Referring now to the drawings which form a part of the disclosure herein, a heater 20 shown in FIG. 1 is one preferred embodiment of the present invention and is shown installed in a heated process chamber 22, shown schematically, which could be included in equipment utilized in manufacture of glass sheet components for display devices such as liquid crystal displays. A sheet 24 of glass to be heated may have a small thickness, such as 0.6 mm, but may have a relatively large length and width, for example, 90 inches×100 inches (229 cm×254 cm). An upper heating plate or susceptor face 26 is machined to be smooth and flat, in order to provide intimate contact as shown herein, with the sheet 24 of glass over its entire expanse, in order to transfer heat evenly and efficiently to the sheet 24 of glass. For some applications a different surface configuration might be used, including grooves or a pattern of raised supports, depending on the purpose of the heater.

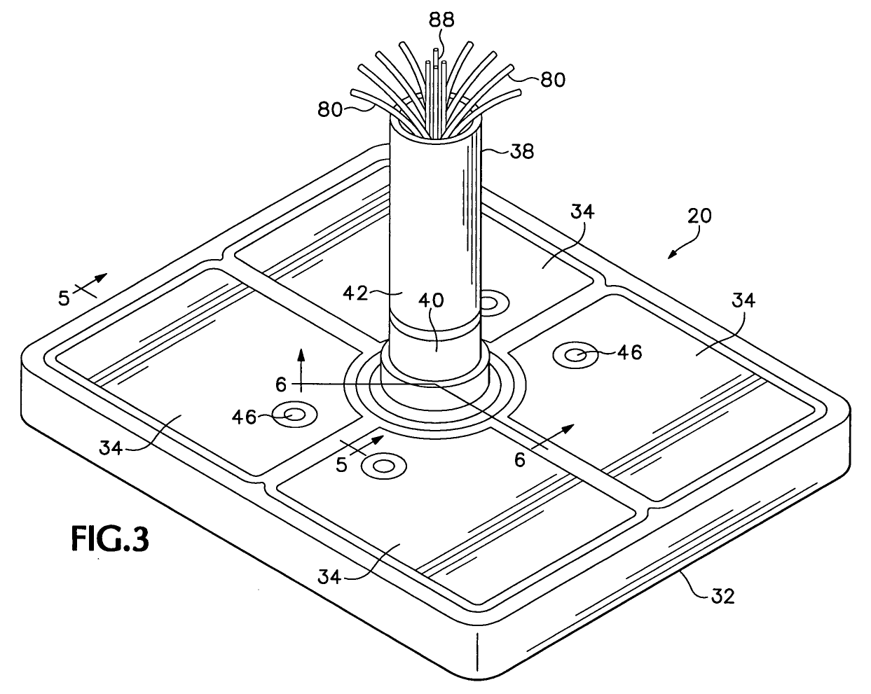

As may be seen in FIGS. 2 and 3, the flat heater plate working surface 26 is raised slightly above the height of the surrounding margin portions 28 of the heater body.

The heater 20 includes a housing having an upper member 32 incorporating a heating body and defining the working or heating surface 26. Such a heating body is preferably of a metal having good heat conduction characteristics, such as an aluminum alloy. The heating body acts as a heat sink to accept heat from heating elements within the housing and conduct the heat to the heating face 26. Because of its heat conduction characteristics and its grain structure, which facilitates machining the heating face precisely to a desired flatness and smoothness, an alloy such as 6061 aluminum is suitable for the upper portion 32 of the heating body.

As may be seen in FIGS. 2, 3, 4, 5, and 6, the heater housing upper member 32 also defines a cavity 33 in its lower side, which is closed by cover plates 34 and an annular flange 36 from which a power feed connector tube 38 extends. A connector tube base portion 40 is preferably integral with the flange 36, and a tube extension 42 is welded to the tube base. The cover plates 34, flange 36 and the power feed connector tube base portion 40 and its extension 42 may also be of a conventional aluminum alloy such as 6061 aluminum. The flange 36 of the tube base portion 40 fits between arcuate portions of the margins of the cover plates 34 and the tube extension 42 abuts against the tubular portion of the tube base. The cover plates 34 are securely welded to the upper member of the housing along the outer walls and divider walls of the cavity, and the flange 36 of the tube base portion 40 is also welded to the cover plates 34, which are appropriately shaped to mate with the flange 36 of the tube base.

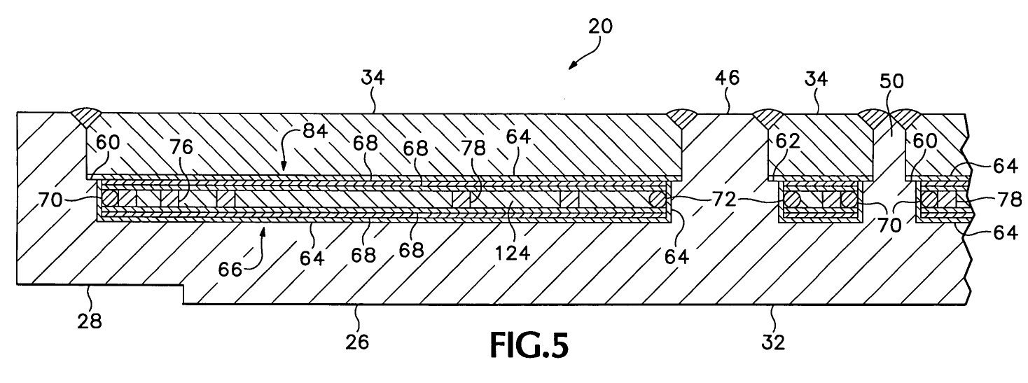

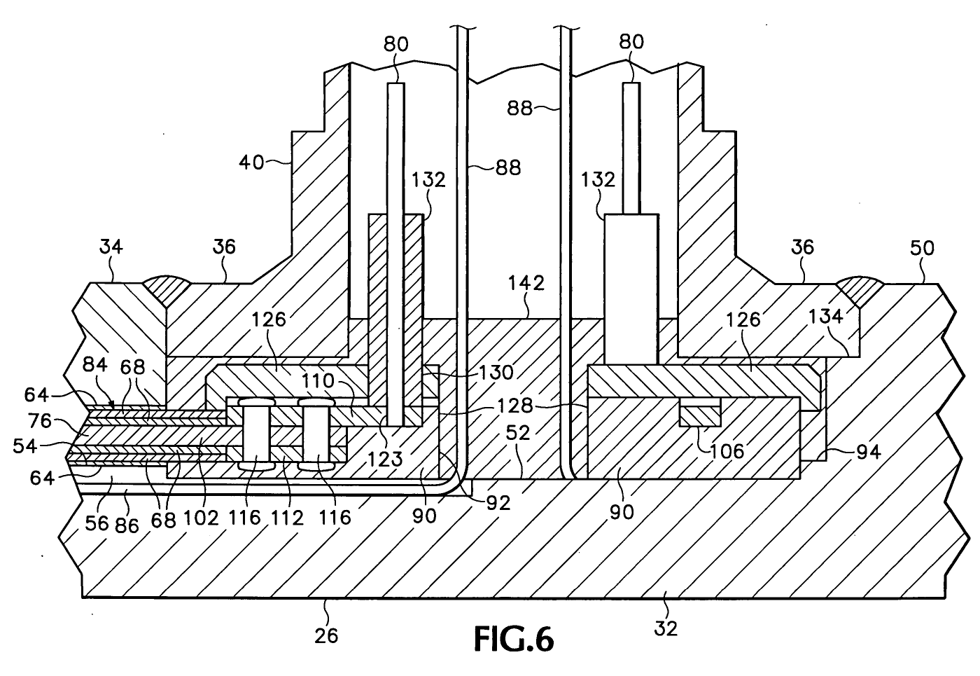

For some applications the housing, including the upper member 32, cover plates 34, and connection tube 38 could be of corrosion resistant stainless steel. As shown best in FIGS. 5 and 6, each of the cover plates 34 is located with respect to the housing upper member 32 by cavity side walls 44 and by a respective locator post 46 which fits within a corresponding hole 48 defined in each of the cover plates.

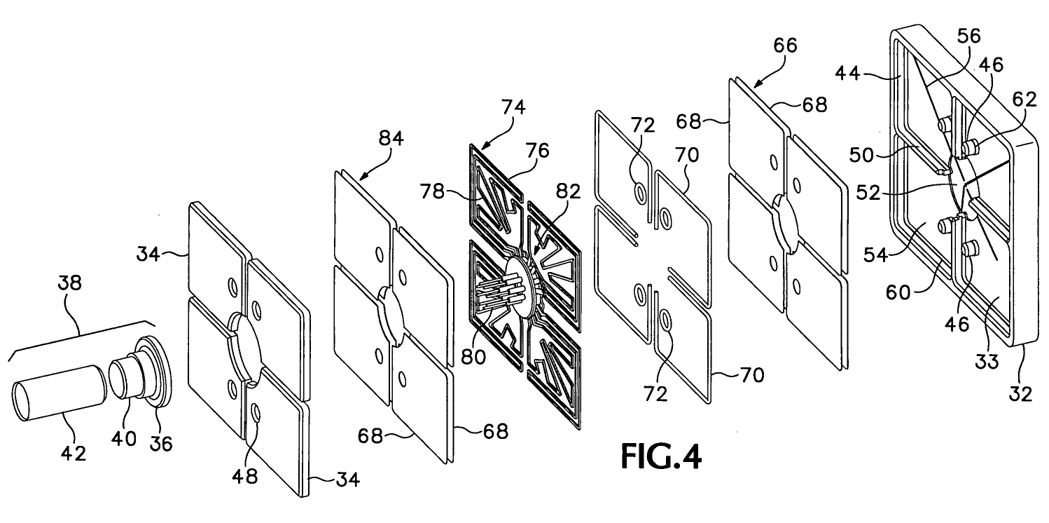

Referring next to FIG. 4, which shows the heater in an exploded view, it will be seen that the cavity 33 defined in the upper member 32 of the housing is divided into four quadrants by divider rails 50 which extend inward from each side wall 44 toward a circular central area 52 which is slightly deeper than the rest of the cavity. It will be understood that the division into quadrants is not critical, and that more or fewer segments may be provided, so long as a portion of each such segment extends to the center of the cavity 33.

The cavity 33 has a generally planar bottom surface 54, parallel with the flat heating plate face 26 mentioned previously. Grooves 56 extend radially from the central area 52 of the cavity to receive thermocouples that can be used to monitor the temperature of the heater 20 during operation. Ledges 60 extend along each divider rail 50 and along the side walls 44 of the cavity, and a similar ledge 62 extends around each cover plate locating post 46. All of the ledges 60, 62 are coplanar, in order to support the cover plates 34, as may be seen in FIG. 5.

The bottom surface 54 and adjacent surfaces of the side walls 44 of the cavity 33 are coated with a slip layer described below and shown in FIGS. 5, 6, 7, and 8 of a lubricious, preferably electrically insulating, material that is capable of withstanding the temperatures to be encountered. Preferably the material of the slip layer is a coating that may be applied by brushing, spraying, or dipping. A preferred material for this slip layer coating is extremely finely powdered boron nitride powder of a type readily available for use as a release coating in coining and die forging. Such powder is available in a water suspension from GE Advanced Ceramics of Strongville Ohiothat can be applied by spraying. Preferably, two successively applied thin coats of such powder are utilized to provide a slip layer having a thickness of about 0.025 mm.

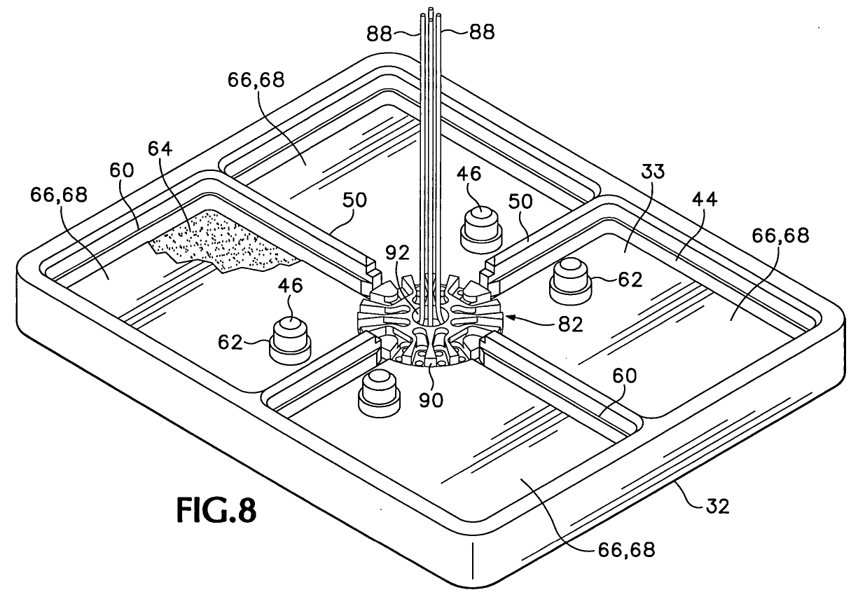

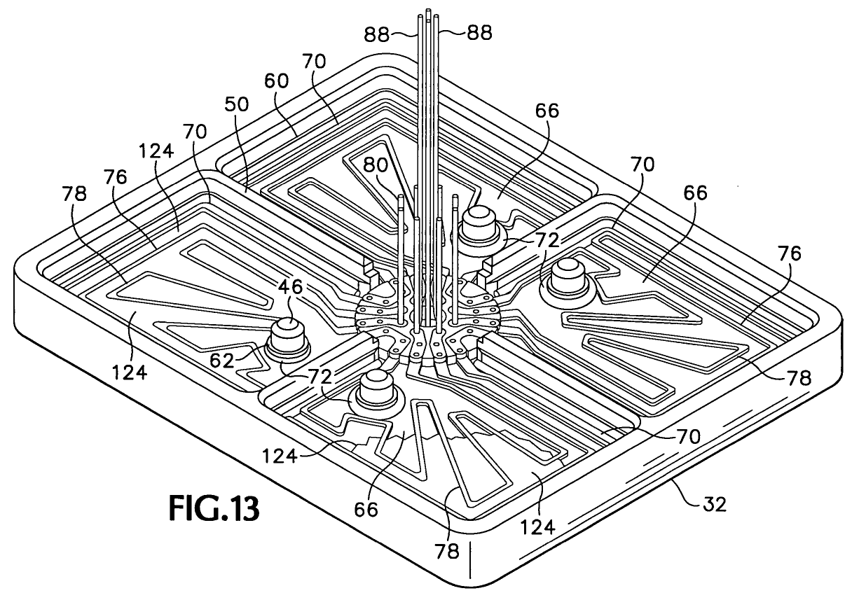

A layer 66 of insulating sheet material is placed in each quadrant against the slip layer, 64, as shown also in FIG. 8. The layer of insulating sheet material 66 may be of any material possessing the needed insulating capability and having an ability to withstand the intended operating temperature range of the heater 20 without emitting anything detrimental to the resistance heating elements. While good thermal conductivity of this electrically insulating material would be advantageous, the requirement for electrical insulating strength is primary. Such materials as paper of pure alumina fiber, or of a blend of alumina and silica fibers, or sheets of mica, could be used. One material which has been found to be satisfactory is an alumina fiber-based paper, free of resin binders, available from Thermal Ceramics of Augusta, Ga., as its K-Shield-BF insulating paper, which has a nominal thickness of 1/32 inch (0.8 mm), and two sheets 68 of such paper are used, as shown in FIG. 4. Within each quadrant of the cavity 33, a rope or cord 70 of electrically insulating fiber material, such as braided resin binder-free alumina fiber, extends around the periphery of the quadrant, along the quadrant dividing rails 50 and along the cavity side wall 44, as shown most clearly in FIG. 13. Similarly, a loop 72 of the same sort of cord is placed around the cover locating post 46 in each quadrant. The insulating rope 70 or 72 is preferably flexible and resilient enough to accept a small amount of compression resiliently and has a diameter great enough to fill the available space around the periphery of each quadrant beneath the cover plates, preferably being slightly compressed.

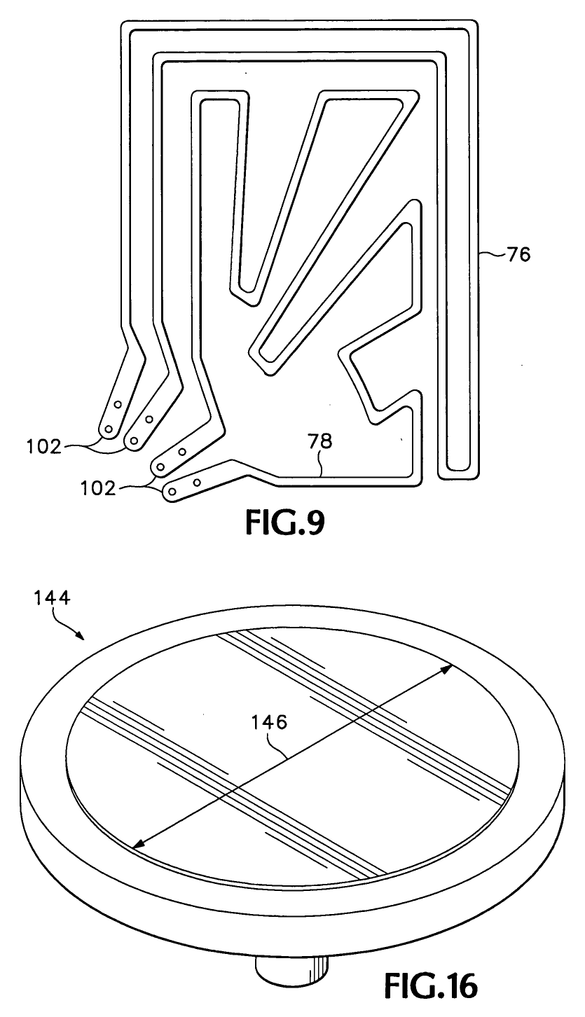

A resistive heating assembly 74 includes an array of electrically resistive heating elements 76 and 78, shown in greater detail in FIG. 9, that are arranged within the cavity defined within the upper member 32 of the housing. Each heating element 76 or 78 includes a resistive carbon conductor cut to the required dimensions, and connected with power leads 80 within corresponding recesses defined in an alignment fixture 82, as may be seen also in FIG. 6. The heating elements have been successfully cut using the water jet cutting process. The cross-sectional area of the conductor in a particular portion of each heating element 76 or 78 will determine the resistance and thus the resulting power output and temperature developed in that portion with a certain voltage applied to the respective heating element.

A preferred material for the heating element conductor portions is a resin-free carbon fiber reinforced carbon material of woven graphite fibers filled with additional carbon, available in sheet form from SGL Carbon Group of Sinking Springs, Pa., as its type 1501G graphitized carbon fiber reinforced carbon material. Other carbon and graphite materials may also be satisfactory, although a resin-free composition is preferred in order to avoid undesirable gaseous emissions resulting from the high temperatures to which the conductors are subjected in use. The preferred carbon fiber materials increase in strength as their temperature rises, resulting in the heating elements being able to withstand the thermally induced stresses of rapidly heating the heater over many cycles without failure of the resistance heating elements.

An insulating and isolating alignment body 82 shown in greater detail in FIGS. 6 and 8 is centrally located and has a generally circular base portion 90 including radially inwardly directed rounded notches spaced around its margin that mate with the inner ends 94 of the quadrant divider rails 50 so as to orient the alignment body 82 properly with respect to the upper member 32 of the housing. The alignment body 82 is of a dielectric or electrically insulative material able to withstand the expected voltages and temperatures, and is preferably made of alumina, which may either be precisely molded or machined to the required configuration.

A layer 84 of insulating sheet material which may be the same as that of the insulating layer 66 is located between the heating assembly 74 and the covers 34 and flange 36, and a slip layer 64 is also provided on the inner face, the surface facing toward the layer 84 of insulating sheet material, of each cover plate 34. The layers 66 and 84 thus extend on opposite sides of the heating elements 76 and 78 and of the insulating cords 70 and 72, as may be seen best in FIGS. 5 and 6. As will be more fully explained presently, in the assembled heater 20 potting material fills the spaces between the insulating cords 70 and 72, the insulating layers 66 and 84, and the heater elements 76 and 78, in each quadrant of the cavity 33.

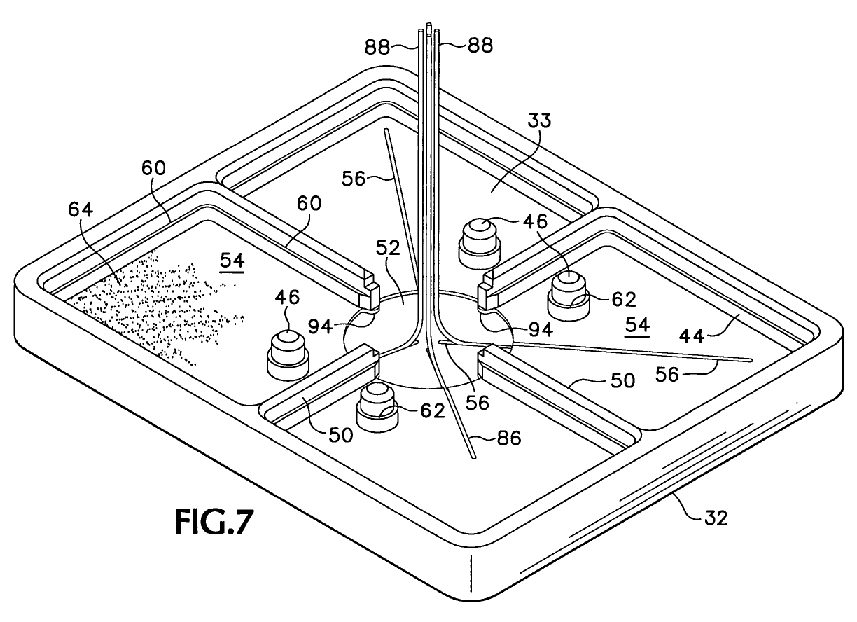

Referring to FIGS. 5 and 6, the structure of portions of the completed heater 20 is shown in section view in enlarged detail, and the process of assembling the heater will now be described with reference also to FIGS. 7-15.

FIG. 7 shows the upper member 32 of the housing of the heater 20 inverted, with its heating face 26 facing downward and the cavity 33 facing openly upward. Thermocouples 86 are installed in the several grooves 56, as desired for monitoring the temperature of the heater 20 at various locations in the heating body. The slip layer 64, indicated by stippling in FIG.7, is applied to the bottom surfaces 54 of the cavity 33, as explained above, once the thermocouples 86 have been installed.

The base portion 90 of the alignment fixture 82 is then placed into the recessed central area 52 in the cavity 33, as shown in FIG. 8, with the thermocouple leads 88 extending upward through a central through-hole 92 and the power feed connector tube 38. The alignment fixture base portion 90 is aligned properly with the upper member 32 by engagement of notches around the periphery with corresponding rounded intrusions 94 at the inner ends of the divider rails 50, as shown in FIG. 7.

Once the base portion 90 is in place, the several sheets 68 of alumina paper of the insulating layer 66 are placed into their respective quadrants, as shown in FIG. 8, so that one of the sheets 68 in each quadrant is in contact with the slip layer 64, shown in FIG. 8 where the layer 66 of insulating material is shown cut away in a portion of one quadrant of the cavity 33. Each sheet 68 of alumina-based paper is cut to fit within its respective quadrant of the cavity 33.

Once the layer 66 of insulating material is in place in contact with the slip layer 64 in each quadrant the heating assembly 74 may be installed with the resistive heater elements 76 and 78 resting on the layer 66 of insulating material.

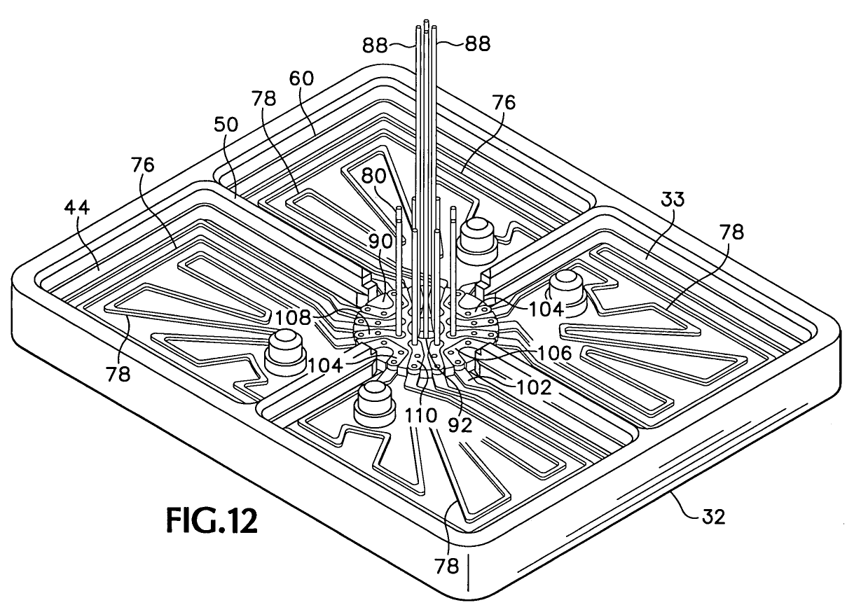

The individual electrical resistance heating elements 76, 78 are all generally coplanar with each other, with each being made as by water jet (the insulating paper is laser cut) cutting the carbon conductor sheet material to the required shape from a planar plate or sheet of a uniform thickness, so that the width of the conductors at various locations determines the electrical resistance through any particular portion of the length of each heating element. As will be readily understood, this permits each heating element to be designed to operate at the required temperature in each part of its length, to distribute heat as required to produce an even temperature distribution over the heating plate face 26 of the upper member 32 of the housing. Thus, in the heater 20 shown herein, there are two heating elements 76, 78 in each quadrant with one heating element 76 extending as a folded loop generally about the periphery of the quadrant, while the second, separately fed, heating element 78, extends in a serpentine pattern in an interior portion of the quadrant. Jumper connector bars 104 are used to interconnect in series as a separately powered heating unit the ones of the inner elements 78 whose terminal portions 102 are adjacent opposite sides of one of the divider bars 50, as shown best in FIG. 12. Jumper connector bars 106 are used similarly to interconnect in series as a separately powered heating unit the terminal portions 102 of outer heater elements 76 whose terminal portions 102 are adjacent opposite sides of another one of the divider bars 50. Terminal bus bars 108 and 110 interconnect the opposite terminal portions 102 of each series-connected pair of heater elements 76 or 78 with their respective power leads 80. This arrangement permits the outer heater elements 76 to be powered and controlled separately from the inner heater elements 78 within the heater, giving some flexibility in the ability to control the temperature of the heating face 26 to keep the temperature even across the entire extent of the heating face 26. Depending upon the size and configuration of a particular heater, different configurations of such carbon conductors of resistance heating elements, and additional subdivision of the power connections to the separate heating elements, may be provided as desired in order to satisfactorily control the temperature of the heating face 26, in response to temperature sensors such as the thermocouples 86.

In order to avoid a surplus of heat emanating from the group of closely associated heating elements 76 and 78 near the center of the heater 20, the terminal portion 102 of each of the heating elements is wider, resulting in less resistance and less resultant heat where all of the heating elements approach each other. Similarly, at corners in the heating elements, the conductor material is wider, in order to provide additional strength and help to prevent breakage during assembly. Because the heating elements 76 and 78 made of the previously described carbon material can withstand higher temperatures, they can be shaped as desired and spaced as close together or as far apart as desired, and it is thus possible to provide relatively close spacing and to have heat conducted from the heating elements 76 and 78 to heat the upper member 32 of the housing more uniformly than is possible with the previously used cable-type heating elements fitted closely in grooves in a heat sink.

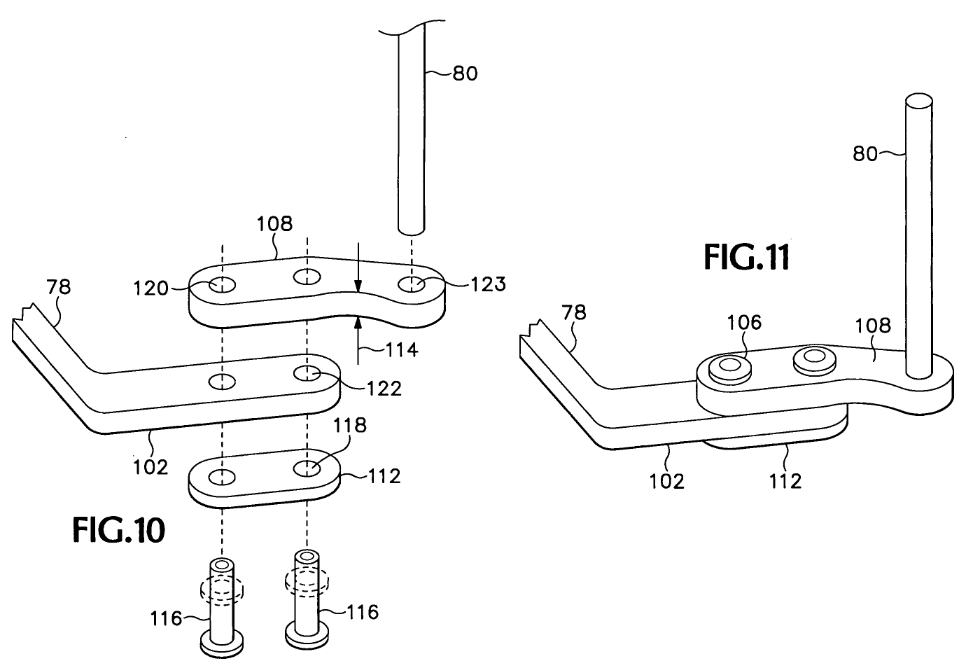

In the heater shown herein each heating element 76 and 78 is cut from sheet material having a thickness of 2.5 mm. As may be seen in FIGS. 10 and 11, a thin backing plate 112 extends along a terminal portion 102 of each heating element conductor. The terminal bars 108, 110 and jumper bars 104, 106, are thicker, having a thickness 114 of, for example, ⅛ inch (3.175 mm) and are provided on the opposite side of respective terminal portions 102 for use as connecting portions extending away from the terminal portion 102 of each heater element 76 or 78. The jumper connector bars 104 and 106 are similar in thickness.

The backing plates and terminal bars 108, 110, or jumper bars 104, 106 are fastened to each other by rivets 116 extending through aligned bores 118, 120, and 122 in, respectively, the backing plates 112 and terminal bus bars 108, 110 or jumper bars 104, 106 and terminal portions 102 of the heater elements 76 and 78. Preferably the rivets 116 are solid bodied, tubular ended rivets. The power leads 80 are preferably rods welded (GTAW) into respective holes 123 in the terminal bars 108 and 110. Preferably the backing plates 112, terminal bars 108 and 110, and jumper plates 104 and 106 are all of nickel 200 alloy, the power lead rods 80 are of nickel 99, and the rivets 116 are of Monel other nickel alloy, in order to avoid presence of any ferrous material together with the carbon of the resistive heating elements 76 and 78, since ferrous material reacts with the carbon of the heating elements adversely at the temperatures expected within the heater.

The terminal rods of the power leads 80, and the rivets 116 may preferably be about ⅛ inch in diameter, while the length and width of the jumper bars 104, 106, terminal bars, 108, 110, and backing plates 112 are designed to be large enough to provide low resistance electrical connections to the terminal portions 102 of the heating elements 76 and 78. The backing plates 112, jumper bars 102, 104 and terminal bars 108, 110 may be manufactured from sheet material by conventional means, such as water jet cutting. The alignment fixture base portion 90 receives all of the jumper bars 104 and 106 and the terminal bus bars 108 and 110 snugly in appropriately shaped cavities, as shown in FIGS. 6, 12, and 13.

Once the heating assembly 74 is placed in the cavity 33, appropriate lengths of insulating cord 70 are placed along the quadrant divider bars and the walls of the cavity, and a loop 72 of the insulating cord is placed around each cover locator post 46. The spaces within the quadrants, between the peripheral insulating cords 70 and resistive conductors of the heating elements 76 and 78, and between the conductors of the heating elements are then filled with potting material 124, installed carefully, to ensure as well as possible, that no air bubbles are left and that the entire available space is filled to the level of the upper surfaces of the heating elements 76 and 78, as shown in progress in FIG. 13. If desired, a thin layer of potting material 124 may be applied to the layer 66 of insulating sheet material prior to insertion of the heating assembly 74, but that is not necessary, nor is it necessary to insert so much of the potting material 124 that the upper (as shown in FIG. 13) surfaces of the heating elements 76 and 78 are covered.

Because of the electrical potential, for example 480 volts, between neighboring portions of the resistance heating elements 76 and 78, an electrical insulation material is needed between them. The potting material 124 also serves to protect the carbon conductor material of the heating elements from the deleterious effects of oxidation, by preventing oxygen from reaching the surfaces of the heating elements. With the heating assembly 74 of heating elements 76 and 78, terminals 108 and 110, and jumpers 104 and 106 in place in the cavity 33 defined by the upper member of the housing, and with the terminals and jumpers located in and insulated from each other by the base portion 90 of the insulation and alignment fixture 82, potting material is placed in the interstices between the heating element conductors and between the heating elements and the insulating alumina fiber cords 70 and 72. The electrically insulating cords 70 extend around the potting material and the loops 72 of insulating cord prevent the potting material from extending fully to the cover locator posts 46. The space between the heating element conductors and between the conductors and the insulating cords 70 and 72 is filled with uncured potting material after the heating assembly is placed into position within the cavity atop the layers of insulating material and before the additional pair of sheets 68 of insulating alumina fiber paper of the layer 84 are placed atop the heating assembly 74.

The potting material 124 preferably has a coefficient of thermal expansion similar to that of the carbon fiber reinforced carbon conductors of the heating elements. Although the insulating ability of the potting material, once cured, must be sufficient to protect the heating elements electrically, it is also desired that the potting material have a high thermal conductivity, in order to transfer heat from the heating elements 76 and 78 to the housing of the heater 20, including the upper member 32 and the cover plates 34. While other satisfactory potting materials may be available, one preferred potting material is a chemical-setting zirconium-silicate and magnesium oxide blend which is available in powder form from JA Crawford Company of Livermore, Calif. as Sauereisin #8, which must be mixed with an appropriate amount of water to form a viscous and adhesive potting material with a consistency similar to pancake batter. Such potting material cures chemically into a solid state within about two hours, although a longer period is required before full strength and complete curing has been achieved.

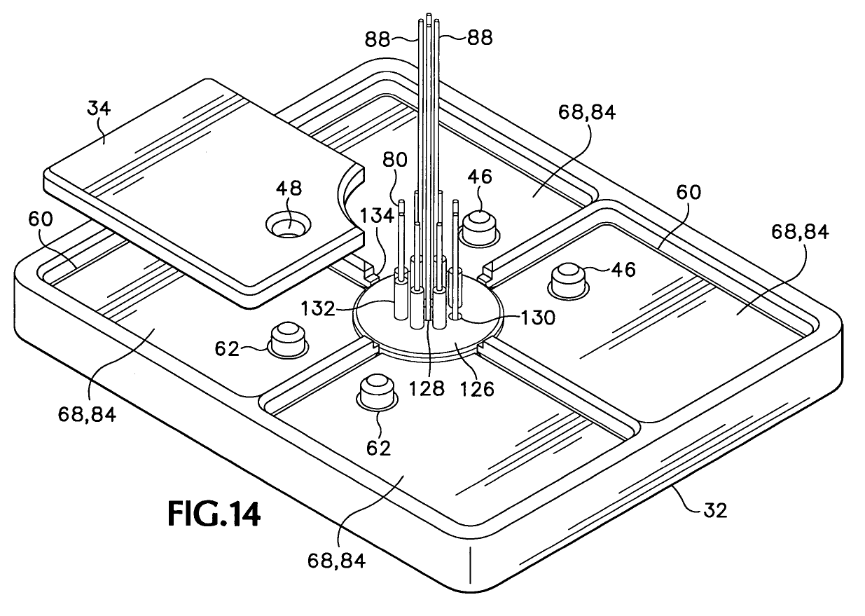

Once the potting material 124 is installed in each quadrant of the cavity 33 the remaining layer 84 of insulating sheet material is installed over the potting material 124 and the heating assembly 74, as shown in FIG. 14. The cover portion 126 of the alignment fixture 82, also of alumina, is then installed, with the thermocouple leads 88 extending through the central through-hole 128 and with the terminal rods 80 extending through individual holes 130 provided in the alignment fixture cover. Insulating tubes 132 are installed on the power lead terminal pins 80, as shown in FIG. 14, extending into the holes 130 in the cover 126 as best seen in FIG. 6.

The alignment fixture cover 126 covers terminal bars 108 and 110 and jumper bars 104 and 106. The cover plates 34, one for each quadrant, are provided with a slip layer 64 coating similar to that applied to the bottom surfaces 54 of the cavity 33 in the upper member 32 of the heater housing.

Thereafter, and before the potting material 124 has time to solidify and cure, the cover plates 34 and the flanged connector tube base portion 40 are fitted into place atop the electrically insulating layer 84 of insulating sheet material and the alignment fixture cover portion 126, and the cover plates are placed atop the layer of insulating sheet material 84 where their position is established with respect to the upper member 32 of the housing. The cover plates 34 are pressed toward the upper member 32 of the heater housing so that the margins of each cover sheet 34 rest upon the ledges 60, defined along the divider bars 50 and the cavity walls 44, and the ledges 62 on the locator posts 46. The flange 36 is pressed into place in contact with and supported by the tables 134 defined on the inner ends of the divider rails 50, preferably located to be coplanar with the ledges 60 and 62.

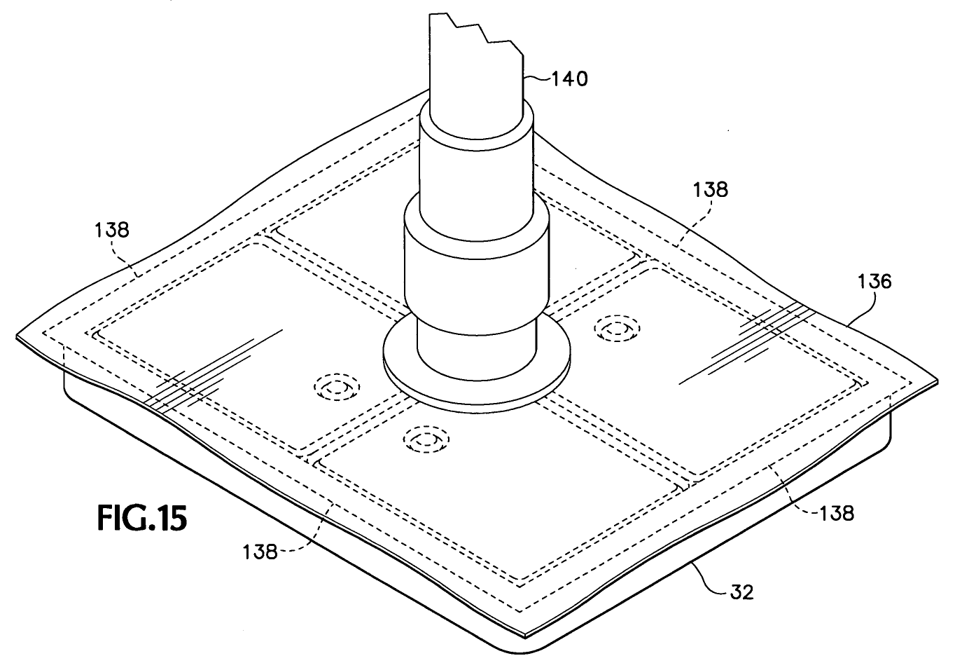

The upwardly-facing bottom of the heater assembly is then “vacuum bagged,” that is, covered with a gas-tight film 136 of flexible film sealed around the periphery of the upper member 32 by an adhesive strip 138, with an opening located at the mouth of the tube base and sealed around the flange 36, as shown in FIG. 15. A vacuum hose 140 is connected to the tube base portion 40 to evacuate and thus remove any air from the interior of the heater housing consisting of the assembled upper member 32, cover members 34, and tube base 40, so that atmospheric pressure against the flexible film 136 presses the cover plates and tube base member into the intended positions against the ledges 60 and 62 and tables 134 of the upper member 32 of the housing during the entire period required for the potting material to solidify and cure sufficiently to unify the portions of the heating assembly 74 within the cavity 33.

The bag 136 and vacuum connection hose 140 are then removed from the heater 20, which is then placed into an oven, to be heated gradually to a temperature of about 200° C. and kept at that temperature long enough for any residual water to be driven off from the potting material.

Once the potting material has thus been thoroughly cured and dried, the heater 20 is clamped in place on a flat surface, still inverted as shown in FIGS. 12-15, and the cover plates 34 are held securely in place and carefully welded to the upper member 32 of the housing, preferably using GTAW welding, tacking the cover plates into position with apart-spaced short welds initially and thereafter completing the welds gradually, in order to avoid thermally-induced distortion of the housing. The flange 36 of the tube base portion 40 is similarly welded to the divider rails 50 and to the adjacent margins of the cover plates 34. Thereafter, power cable terminations are made to the exposed ends of the terminal rods, and the connector tube extension 42 is welded to the tube base portion 40.

A quantity of potting material 142 is inserted in the central area within the connection tube base portion 40, as shown in FIG. 6, to fill the remaining voids. Once the added potting material 142 has cured the heater may again be dried in the oven to drive off water from the additional potting material.

Once assembly of the heater as described above has been completed and the weld joints have been machined flat, the entire heater is annealed, to relieve residual stress in the aluminum housing resulting from the welding process. The working surface 26 of the upper member 32 is then machined to a final flatness or other desired surface configuration, as required for the intended application of the heater 20.

Finally, the entire outer surface of the heater 20 may be anodized to provide suitable protection for the aluminum surface of the heater against the atmosphere within the chamber 22 in which the heater is to be operated during manufacturing processes.

When the heater is in use the temperature of the working face 26 is sensed by the thermocouples 86, whose output may be connected to an appropriate microprocessor (not shown) used to control the voltage provided to the power input leads 80 of the several heating elements 76 and 78, to deliver electrical currents sufficient to raise the temperature of the heater 20 at a desired and safe rate and to maintain a uniform temperature distribution across the entire area of the heating face 26. As the temperature of the heating face 26 is being raised the difference between the thermal expansion of the aluminum housing and of the hotter heating elements 76 and 78 is accommodated by the ability of the heating elements 76 and 78 to move relative to the housing as a result of the slip layers 64 between the electrically insulating sheets and the housing. Changes in relative size of the heating assembly 74 and the cavity 33 within the housing is accommodated by the ability of the insulating cord 70 surrounding the heating assembly 74 to be compressed and to return to its original dimension with changes in the available space. The available freedom for movement of the heating assembly relative to the housing permits the temperature of the heater 20 to be raised more quickly than was safe with previously known susceptors and heaters, without thermal stresses or hot spots that would cause the heating elements to fail or crack. The ability of the carbon fiber reinforced carbon material of the heating elements 76 and 78 to withstand high temperatures allows the heating elements to be driven to provide ample heat to raise the temperature of the heater case at a significantly higher rate of change of temperature than was possible using the previously known cable type heater elements held in heater housings. Thus the heater 20 can be heated at a rate of change of temperature greater than 3° C. per minute and at least as great as 10° C. per minute over many cycles of heating and cooling from about 20° C. to 500° C., and can reliably be operated at temperatures in the range of 350° C. to 500° C. over long periods. It is expected that the temperature of such a heater 20 can be increased at least over the range of 20° C. to 500° C. as rapidly as 16° C. per minute without failure of the carbon conductors 76 and 78.

Referring to FIG. 16, a heater 144 is similar in structure to the heater 20, but is in the form of a circular susceptor with a diameter 146 of about 300 mm, for use in production of semiconductor wafers. It will be understood that the heater may be made in other sizes and configurations by appropriately designing the resistance heating elements used therein.

The terms and expressions which have been employed in the foregoing specification are used therein as terms of description and not of limitation, and there is no intention, in the use of such terms and expressions, of excluding equivalents of the features shown and described or portions thereof, it being recognized that the scope of the invention is defined and limited only by the claims which follow.

I claim:

1. A heater, comprising:
(a) a housing including an exterior heating surface and an interior cavity;
(b) an electrical heating unit contained within said cavity and electrically insulated from said housing, said heating unit including a resistance heating element and an electrical terminal connected electrically to said resistance heating element; and
(c) a slip layer of material located between said heating element and an interior surface of said cavity, said slip layer allowing said heating element to move with respect to said housing in response to a change in temperature of at least one of said housing and said heating element.

2. The heater of claim 1 wherein said resistance heating element includes a resistive conductor of carbon.

3. The heater of claim 1 wherein said housing is of an aluminum alloy.

4. The heater of claim 1 wherein said housing is of a corrosion resistant steel.

5. The heater of claim 1 including a layer of an electrically insulating material between said heating element and said slip layer.

6. The heater of claim 5 wherein said layer of electrically insulating material includes an alumina fiber paper.

7. The heater of claim 5 wherein said electrically insulating paper is compressible in order to accommodate thermal expansion of said resistance heating element in a direction parallel with a thickness of said paper.

8. The heater of claim 5 wherein said layer of electrically insulating material includes a sheet of paper including silica fiber.

9. The heater of claim 5 including an electrically insulating cord extending around a periphery of said heating unit within said housing.

10. The heater of claim 9 wherein said electrically insulating cord is of ceramic fiber.

11. The heater of claim 10 wherein said electrically insulating cord is of woven alumina fiber.

12. The heater of claim 1 wherein said housing includes a first member including said heating surface on an upper side thereof and defining a cavity aligned with said heating surface in a lower side of said first member, said housing also including a closure member fastened to said first member and enclosing said heating unit in said cavity.

13. The heater of claim 1 wherein said resistance heating element is protected by an electrically insulative potting material in contact with lateral surfaces thereof.

14. The heater of claim 12 wherein said potting material and said resistance heating element have similar coefficients of thermal expansion.

15. The heater of claim 1 wherein said electrical terminal includes a pair of contact members located respectively on opposite sides of a terminal portion of said resistance heating element and attached thereto by a fastener extending through aligned bores defined respectively in said contact members and in said terminal portion of said electrical resistance heating element.

16. The heater of claim 1 wherein said electrical terminal is located in a central portion of said cavity, so that any differential thermal expansion of said heating unit with respect to said housing occurs in a generally radial direction with respect to said heating face.

17. The heater of claim 1 wherein said slip layer includes a coating of boron nitride powder on an interior surface of said cavity.

18. The heater of claim 1 including a plurality of said resistance heating elements.

19. The heater of claim 1 further comprising a heating assembly including a plurality of said heating units.

20. The heater of claim 19 including a temperature sensing device.

21. The heater of claim 20 including a plurality of said temperature sensing devices, and wherein at least one of said heating units is controlled separately from another one.

22. The heater of claim 1 including a second said slip layer, one of said slip layers being on each of a pair of opposite upper and lower sides of said heating element, and further including a respective layer of an electrically insulating material between said heating element and each said slip layer.

23. The heater of claim 22 including an electrically insulative potting material substantially filling a space between said layers of electrically insulating material and at least partially bounded by said heating element.

24. A heater operable at an operating temperature of at least 500° C., comprising:
(a) a housing including an exterior heating surface;
(b) an electrical heating unit contained within and electrically insulated from said housing, said heating unit including a resistance heating element consisting substantially of conductive carbon and an electrical terminal connected to a terminal portion of said heating element; and wherein
(c) said heating element is embedded in an electrically insulative potting material able to withstand said operating temperature.

25. The heater of claim 24 wherein said heating element is of carbon fiber reinforced carbon.

26. The heater of claim 24 wherein said heating element is generally planar and of substantially uniform thickness.

27. The heater of claim 26 wherein said heating element is elongate and includes portions of different widths whereby electrical resistance is varied along a length of said heating element.

28. The heater of claim 24 wherein said potting material includes a chemically set ceramic material.

29. The heater of claim 24 wherein said potting material comprises a water activated cement.

30. A method of assembling a heater, comprising:
(a) providing an outer housing member defining a cavity;
(b) coating an interior surface of the outer housing member with a quantity of a material, thereby forming a slip layer;
(c) installing a first sheet of electrically insulating material adjacent said slip layer;
(d) installing a resistance heating element including a conductor of carbon and associated electrical leads into the cavity;
(e) thereafter installing an additional sheet of electrically insulating material adjacent to said heating element;
(f) coating an interior surface of a cover plate with a quantity of said material, thereby forming a slip layer;
(g) thereafter installing said cover plate and fastening said cover plate to said outer housing member, thereby closing said cavity.

31. The method of claim 30 including installing a quantity of a potting material within said cavity and in contact with said electrical resistance heating element after installing said heating element into said cavity and prior to installing said additional sheet of electrically insulating material.

32. The method of claim 31 including the step of vacuum bagging the heater after installing said cover plate and thereafter permitting the potting material to cure for a predetermined time under vacuum.

33. The method of claim 31 including the further steps of permitting said potting material to cure for a first predetermined time and thereafter warming said heater to a high enough temperature and keeping it there for a second predetermined time in order to dry any residual moisture from said potting material.

34. The method of claim 30 wherein said step of installing potting material includes installation of a water activated potting material.

35. The method of claim 34 including the further steps of permitting said potting material to cure for a first predetermined time and thereafter warming said heater to a high enough temperature and keeping it there for a second predetermined time in order to dry any residual moisture from said potting material.

36. An electrical resistance heater capable of raising a temperature of a heating surface at least 10° C. per minute from a temperature of 20° C. to 500° C. and capable of being operated continuously to maintain said heating surface at 500° C. thereafter.
